(19) United States
(12) Patent Application Publication
(10) Pub. No.: US 2025/0336050 A1
(43) Pub. Date: Oct. 30, 2025

(54) METHOD FOR PROCESSING IMAGE, COMPUTER-READABLE STORAGE MEDIUM, AND ELECTRONIC DEVICE

(71) Applicant: BOE Technology Group Co., Ltd., Beijing (CN)

(72) Inventors: Hao TANG, Beijing (CN); Ronghua LAN, Beijing (CN); Jiuyang CHENG, Beijing (CN); Junrui ZHANG, Beijing (CN); Quanguo ZHOU, Beijing (CN); Zhidong WANG, Beijing (CN); Yancheng LU, Beijing (CN); Lijia ZHOU, Beijing (CN); Qing ZHANG, Beijing (CN); Xuehui ZHU, Beijing (CN); Lirong XU, Beijing (CN); Xiuru SUN, Beijing (CN)

(73) Assignee: BOE Technology Group Co., Ltd., Beijing (CN)

(21) Appl. No.: 18/866,667

(22) PCT Filed: May 8, 2023
(86) PCT No.: PCT/CN2023/092760

§ 371 Date: Nov. 18, 2024

(30) Foreign Application Priority Data
May 19, 2022 (CN) 202210553271.4

(51) Int. Cl. G06T 7/00; G06T 5/30; G06T 5/73

(52) U.S. Cl. CPC G06T 7/0004; G06T 5/30; G06T 5/73; G06T 2207/30148

(57) ABSTRACT

Method for processing an image, a computer-readable storage medium, and an electronic device. The method includes: acquiring a mark area in an original wiring image, and determining a first to-be-detected region of the original wiring image based on the mark area; performing boundary sharpening on the first to-be-detected region to determine a second to-be-detected region, and generating a target detection image based on the first to-be-detected region and the second to-be-detected region; and performing image recognition on the target detection image to detect a crack defect included in the original wiring image.

### CROSS-REFERENCE TO RELATED APPLICATIONS

The present disclosure is the U.S. National phase application of International Application No. PCT/CN2023/092760, filed on May 8, 2023, which claims priority to Chinese patent application No. 202210553271.4, filed on May 19, 2022, entitled “IMAGE PROCESSING METHOD AND APPARATUS, COMPUTER-READABLE STORAGE MEDIUM, AND ELECTRONIC DEVICE”, the entire contents of each are hereby incorporated herein by reference in its entirety.

### TECHNICAL FIELD

Embodiments of the present disclosure relate to the field of image processing technology, and in particular to a method for processing an image, a device for processing an image, a non-transitory computer-readable storage medium, and an electronic device.

### BACKGROUND

Existing methods for detecting crack defects in electrical circuits can be implemented through electrical measurements of metal continuity.

However, since micro-cracks do not cause short circuits in the early stages, the accuracy of the detected crack defects is low.

### SUMMARY

According to an aspect of the present disclosure, there is provided a method for processing an image, including:
acquiring a mark point in an original wiring image, and determining a first to-be-detected region of the original wiring image based on the mark point;
performing boundary sharpening on the first to-be-detected region to determine a second to-be-detected region, and generating a target detection image based on the first to-be-detected region and the second to-be-detected region; and
performing image recognition on the target detection image to detect a crack defect included in the original wiring image.

In an exemplary embodiment of the present disclosure, acquiring the mark point in the original wiring image includes:
acquiring the original wiring image, and performing grayscale processing on the original wiring image to obtain a grayscale wiring image; and
performing binarization processing on the grayscale wiring image to obtain a binarized wiring image, and filtering the binarized wiring image based on an attribute feature possessed by the mark point to obtain the mark point.

In an exemplary embodiment of the present disclosure, performing binarization processing on the grayscale wiring image to obtain the binarized wiring image includes:
acquiring a current brightness value of each pixel point included in the grayscale wiring image and determining whether the current brightness value is greater than a first preset threshold;
in response to the current brightness value being greater than the first preset threshold, replacing the current brightness value of the pixel point with a first preset brightness value;
in response to the current brightness value being less than the first preset threshold, replacing the current brightness value of the pixel point with a second preset brightness value; and
generating the binarized wiring image based on each pixel point after the replacement of the current brightness value.

In an exemplary embodiment of the present disclosure, the method for processing the image further includes:
acquiring, by a preset image acquisition device, the original wiring image from a metal wire surface to be detected, where the image acquisition device includes a large target surface industrial camera and an industrial telecentric lens.

In an exemplary embodiment of the present disclosure, acquiring, by the preset image acquisition device, the original wiring image from the metal wire surface to be detected includes:
configuring an incident angle of a light source between the industrial telecentric lens and the metal wire surface to be detected; and controlling, based on the incident angle, the large target surface industrial camera to acquire the original wiring image from the metal wire surface to be detected through the industrial telecentric lens.

In one exemplary embodiment of the present disclosure, the light source includes one or more of: a ring-shaped light source, one or more point light sources, and one or more strip light sources; and the incident angle ranges from 60° to 85°.

In an exemplary embodiment of the present disclosure, determining the first to-be-detected region of the original wiring image based on the mark point includes:
calculating a center point position of the mark point based on a starting coordinate position of the mark point in the original wiring image and a dimensional feature of attribute features possessed by the mark point;
determining a dimension of the first to-be-detected region based on a proportion of a metal wire included in the original wiring image relative to the original wiring image; and
selecting the first to-be-detected region from the original wiring image based on the center point position of the mark point and the dimension of the first to-be-detected region.

In an exemplary embodiment of the present disclosure, performing boundary sharpening on the first to-be-detected region to determine the second to-be-detected region includes:
performing dilation and erosion processing on the first to-be-detected region to obtain an intermediate detection region; and
performing erosion and dilation processing on the intermediate detection region to obtain the second to-be-detected region.

In an exemplary embodiment of the present disclosure, performing dilation and erosion processing on the first to-be-detected region to obtain the intermediate detection region includes:
extracting a first pixel point to be processed from the first to-be-detected region and deleting the first pixel point to be processed, where a size of the first pixel point to be processed is less than or equal to a first preset pixel value, and a current brightness value of the first pixel point to be processed is greater than a first preset threshold; and
performing smoothing processing on a boundary line of a metal wire included in the first to-be-detected region, and disconnecting an adhesion between two adjacent metal wires to obtain the intermediate detection region.

In an exemplary embodiment of the present disclosure, performing erosion and dilation processing on the intermediate detection region to obtain the second to-be-detected region includes:
extracting a second pixel point to be processed from the intermediate detection region and filling the second pixel point to be processed, where a size of the second pixel point to be processed is less than or equal to a first preset pixel value, and a current brightness value of the second pixel point to be processed is less than a first preset threshold; and
filling a disconnected portion of a metal wire included in the intermediate detection region, and performing secondary smoothing processing on a boundary line of the metal wire without changing an area of the metal wire to obtain the second to-be-detected region.

In an exemplary embodiment of the present disclosure, generating the target detection image based on the first to-be-detected region and the second to-be-detected region includes:
performing a difference operation on a first grayscale value of each pixel point included in the first to-be-detected region and a second grayscale value of each pixel point included in the second to-be-detected region to obtain a third grayscale value, and determining whether the third grayscale value satisfies a preset condition;
in response to the third grayscale value satisfying the preset condition, determining the third grayscale value as a target grayscale value of the pixel point;
in response to the third grayscale value failing to satisfy the preset condition, replacing the third grayscale value and determining the replaced third grayscale value as the target grayscale value of the pixel point; and
generating the target detection image based on the target grayscale value of each pixel point.

In an exemplary embodiment of the present disclosure, performing image recognition on the target detection image to detect the crack defect included in the original wiring image includes:
performing image recognition on the target detection image by a preset image recognition model to detect the crack defect included in the original wiring image;
where the image recognition model includes one or more of: an edge detection model, a convolutional neural network model, a recurrent neural network model, or a deep neural network model.

According to an aspect of the present disclosure, there is provided a device for processing an image, including:
a first to-be-detected region determination module configured to acquire a mark point in an original wiring image, and determine a first to-be-detected region of the original wiring image based on the mark point;
a target detection image generation module configured to perform boundary sharpening on the first to-be-detected region to determine a second to-be-detected region, and to generate a target detection image based on the first to-be-detected region and the second to-be-detected region; and
an image recognition module configured to perform image recognition on the target detection image to detect a crack defect included in the original wiring image.

According to an aspect of the present disclosure, there is provided a non-transitory computer-readable storage medium, having stored thereon a computer program which, when executed by a processor, causes the processor to perform the method for processing the image described in any one of the foregoing embodiments.

According to an aspect of the present disclosure, there is provided an electronic device including:
a processor; and
a memory configured to store instructions executable by the processor;
where the processor is configured to perform the method for processing the image of any one of the foregoing embodiments by executing the instructions.

It should be understood that the above general description and the detailed description that follows are exemplary and explanatory only and do not limit the present disclosure.

### BRIEF DESCRIPTION OF THE DRAWINGS

The accompanying drawings herein are incorporated into and form a part of the specification, illustrate embodiments consistent with the present disclosure, and are used in conjunction with the specification to explain the principles of the present disclosure. It is apparent that the accompanying drawings in the following description are only some of the embodiments of the present disclosure, and other accompanying drawings may be obtained from these drawings without creative labor for those of ordinary skill in the art.

FIG. 1 schematically illustrates a flowchart of a method for processing an image according to exemplary embodiments of the present disclosure.

FIG. 2 schematically illustrates a schematic diagram of an optical path employed to capture an original wiring image according to exemplary embodiments of the present disclosure.

FIG. 3 schematically illustrates an example diagram of an original wiring image acquired based on the schematic diagram of the optical path shown in FIG. 3, according to exemplary embodiments of the present disclosure.

FIG. 4 schematically illustrates an example diagram of a wiring image acquired using other means.

FIG. 5 schematically illustrates an example diagram of difference comparisons of grayscale values at different lighting angles, according to exemplary embodiments of the present disclosure.

FIG. 6 schematically illustrates an example diagram of a first to-be-detected region according to exemplary embodiments of the present disclosure.

FIG. 7 schematically illustrates an example diagram of a metal wire prior to boundary sharpening processing according to exemplary embodiments of the present disclosure.

FIG. 8 schematically illustrates an example diagram of a metal wire after boundary sharpening processing according to exemplary embodiments of the present disclosure.

FIG. 9 schematically illustrates an example diagram of a target detection image (pre-processed result image) according to exemplary embodiments of the present disclosure.

FIG. 10 schematically illustrates an example diagram of a method for detecting a crack defect according to exemplary embodiments of the present disclosure.

FIG. 11 schematically illustrates a block diagram of a device for processing an image according to exemplary embodiments of the present disclosure.

FIG. 12 schematically illustrates an electronic device for implementing the method for processing the image described above, according to exemplary embodiments of the present disclosure.

### DETAILED DESCRIPTION

Exemplary embodiments will now be described more fully with reference to the accompanying drawings. However, the exemplary embodiments can be implemented in a variety of forms and should not be construed as being limited to the examples set forth herein; rather, the provision of these embodiments allows for the present disclosure to be more comprehensive and complete and conveys the concept of the exemplary embodiments in a comprehensive manner to those skilled in the art. The features, structures, or characteristics described may be combined in one or more embodiments in any appropriate manner.

In addition, the accompanying drawings are only schematic illustrations of the present disclosure and are not necessarily drawn to scale. The same symbols in the drawings indicate the same or similar portions, and thus repetitive descriptions of them will be omitted. Some of the block diagrams shown in the accompanying drawings represent functional entities that do not necessarily correspond to physically or logically independent entities. These functional entities may be implemented in software form, or in one or more hardware modules or integrated circuits, or in different networks and/or processor devices and/or microcontroller devices.

The metal wires, e.g., source and drain external wires of display panels, flexible printed circuit (FPC) gold fingers (or called edge connectors) and integrated circuit (IC) package metal wires, in electronic products can play a role in signal transmission. During the usage of electronic products, if cracks appear in the metal wires, there is a significant risk of short circuits, which affects the product's functionality and usage. Therefore, detecting cracks in the metal wires is an urgent problem that needs to be solved.

In order to solve the above problem, some of the methods for performing crack defect detection can be realized in the following ways. One way is to measure the on-off (continuity) of the metal wires electrically. If the metal wire is in a conducting state, it is determined that there are no crack defects in the metal wire. If the metal wire is in a disconnecting state, it is determined that there are crack defects in the metal wire. Another way is to conduct visual inspections manually.

However, the above methods have the following defects. On the one hand, the method of measuring the metal continuity by electrical means is inefficient and not highly reliable (micro-cracks do not directly cause short circuits in the early stages, but are prone to develop into larger cracks in the later stages). On the other hand, the method of visual inspection is more difficult, as reflected in the following: firstly, the size of the crack defect is small since the size of the aforementioned metal wire is usually at the level of micrometers and the width of the crack is less than a micrometer, which makes it more difficult to acquire images or pictures that meet the inspection standards; and secondly, the environmental background is complex, and the metal wiring is intricate, which poses a significant challenge for visual processing.

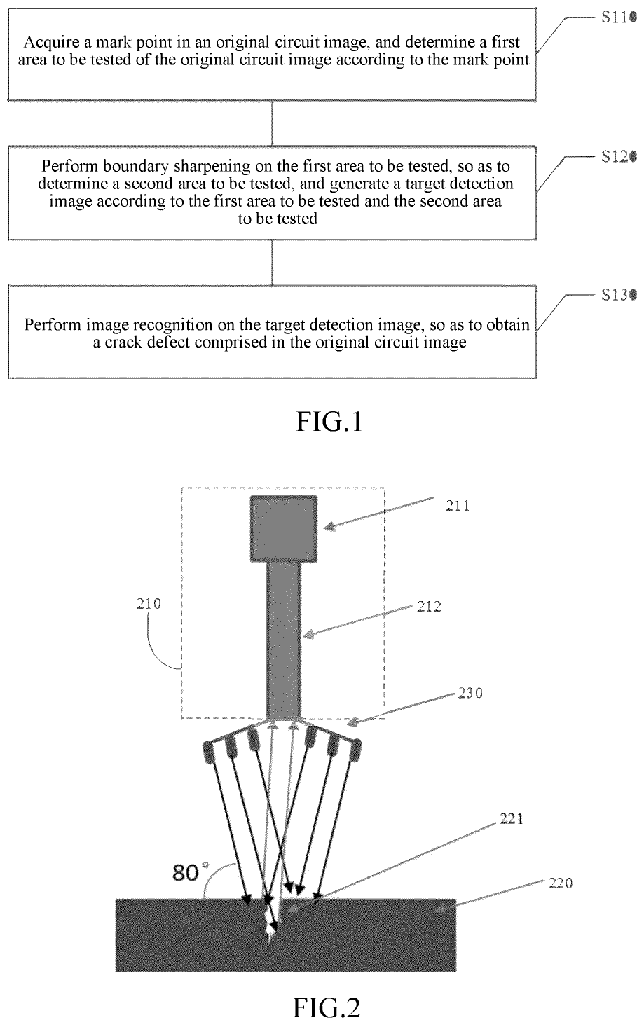

In view of the above, a method for processing an image is provided in this exemplary embodiment, which may run on a terminal device, a server, a server cluster, or a cloud server, etc. Certainly, a person skilled in the art may run the method of the present disclosure on other platforms according to the demand, which is not specifically limited in this exemplary embodiment. Referring to FIG. 1, the method for processing the image may include the following steps.

Step S110, acquiring a mark point in an original wiring image, and determining a first to-be-detected region of the original wiring image based on the mark point.

Step S120, performing boundary sharpening on the first to-be-detected region to determine a second to-be-detected region, and generating a target detection image based on the first to-be-detected region and the second to-be-detected region.

Step S130, performing image recognition on the target detection image to detect a crack defect included in the original wiring image.

In the above method for processing the image, on the one hand, a mark point in the original wiring image is acquired, and based on the mark point, a first to-be-detected region in the original wiring image is determined; then a second to-be-detected region is determined by sharpening the boundary of the first to-be-detected region, and based on the first to-be-detected region and the second to-be-detected region, a target detection image is generated; and finally, an image recognition is carried out on the target detection image and a crack defect included in the original wiring image is detected. Since the crack defects can be detected directly by means of image processing, there is no need to detect them electrically, thus solving the problem of lower accuracy of the detected crack defects in the prior art, which realizes the crack defect detection by measuring the metal continuity. On the other hand, since the corresponding crack defects can be detected by performing image recognition on the target detection image obtained after pre-processing the original wiring image, the accuracy of the detected crack defects is greatly improved, and the detection efficiency of the crack defects is also improved.

Hereinafter, the method for processing the image of the exemplary embodiment of the present disclosure will be explained and illustrated in detail in conjunction with the accompanying drawings.

Firstly, the inventive purpose of the exemplary embodiments of the present disclosure is explained and illustrated. Specifically, in order to solve the problem of detecting cracks in metal wires of Liquid Crystal Display (LCD), Organic Light-Emitting Diode (OLED), Integrated Circuit (IC), Printed Circuit Board (PCB), etc., the exemplary embodiments of the present disclosure propose a scheme for acquiring an original wiring image under a scene of high-angle dark-field light, pre-processing the original wiring image, and finally detecting crack defects from image recognition of the pre-processed original wiring image. In this case, since the original wiring image is acquired under a scene of high-angle dark-field light, the crack features of the metal wires can be clearly captured, which enhances the defect features while weakening the background (increasing the grayscale difference between the defects and the normal background by over 50%), thereby reducing interference. Furthermore, by pre-processing the original wiring image (e.g., filtering out metal wires and shielding background regions), the lower edge features of the metal wires can be weakened, and the background complexity can be reduced, which, in turn, improves the accuracy of detection, and enhances detection efficiency.

Secondly, the schematic diagram of the optical path employed for capturing the original wiring image involved in the exemplary embodiments of the present disclosure is explained and illustrated. Specifically, with reference to FIG. 2, the schematic diagram of the optical path may include an image acquisition device 210 and a metal wire 220 to be detected. The image acquisition device may include a large target surface industrial camera 211 and an industrial telecentric lens 212. A light source 230 is provided between the metal wire to be detected and the industrial telecentric lens. An incident angle is provided for the light source between the industrial telecentric lens and the metal wire surface to be detected. A crack defect 221 exists on the metal wire surface.

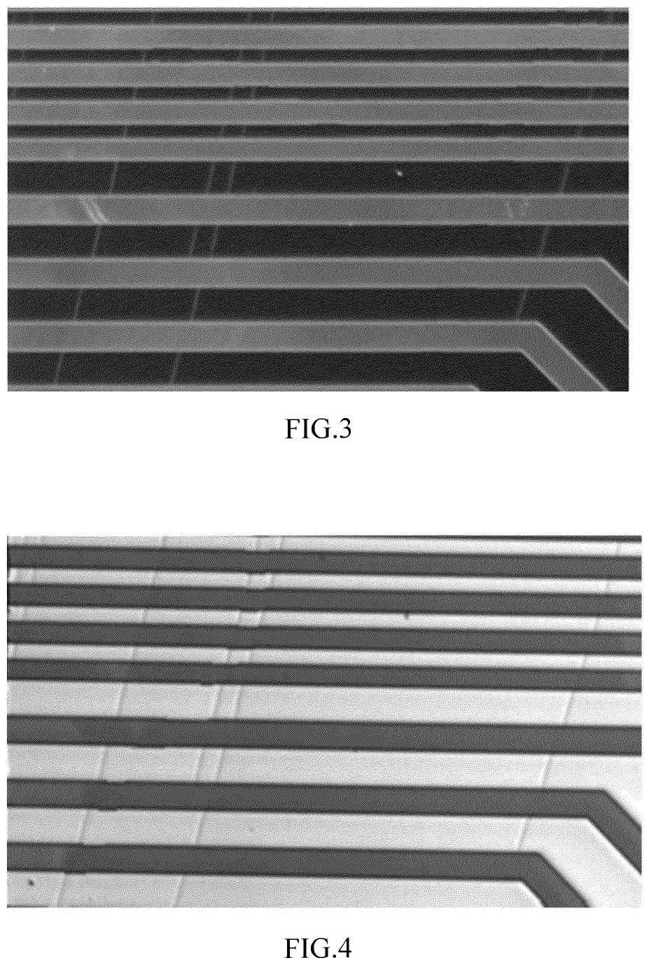

It should be noted that the exemplary embodiments of the present disclosure employ a high-angle dark-field light scheme for image processing, coupled with a large target surface industrial camera and an industrial telecentric lens for image acquisition. The “high-angle” is specifically reflected as: the incident angle of the light source between the industrial telecentric lens and the metal wire surface to be detected is high. Due to the surface of the metal wire is a smooth surface, total reflection will occur when the high-angle light strikes on the metal wire, resulting in no reflected light being captured by the camera. However, when there is a crack on the metal wire, the light strikes on the crack and produces diffuse reflection, so that reflected light is captured by the camera, thus realizing the capture of crack features. In this case, the original wiring image captured can be referred to as shown in FIG. 3. Based on the original wiring image shown in FIG. 3, it can be learned that compared to the image captured by other schemes (specifically, reference can be made to the image shown in FIG. 4), the original wiring image captured by using the optical path diagram described in the exemplary embodiments of the present disclosure, shows a more pronounced crack feature, and the difference in its grayscale value can be up to 50 or more, whereas the grayscale value difference of defects in images acquired by other optical schemes is only 20˜30.

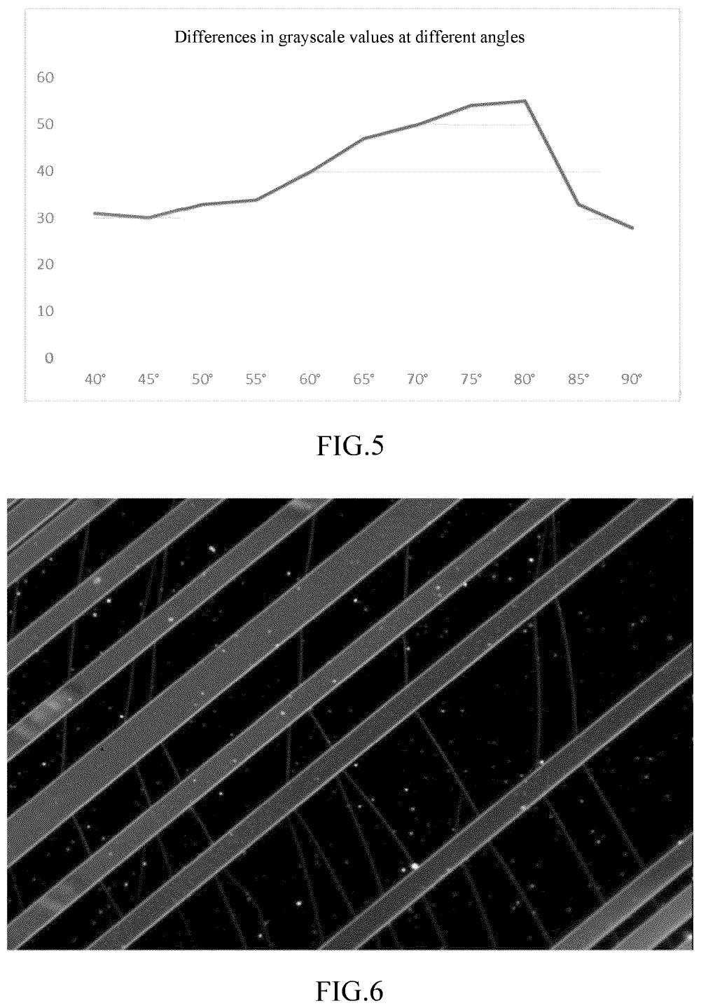

Furthermore, for the light source used in the exemplary embodiments of the present disclosure, a ring-shaped light source, one to several point light sources, or one to several strip light sources can be used individually or in combination according to the specific wiring conditions. Usually, a ring-shaped light source may be preferred. Specifically, comparison of grayscale values at different lighting angles can be seen in FIG. 5. It can be learned from the comparison of grayscale values at different incident angles as shown in FIG. 5, the lighting angle is preferably between 60° and 85°. More preferably, it can be set between 75° and 80°.

Hereinafter, the method for processing the image shown in FIG. 1 is explained and illustrated in detail in conjunction with FIGS. 2-5.

In step S110, a mark point in an original wiring image is acquired, and a first to-be-detected region of the original wiring image is determined based on the mark point.

In this exemplary embodiment, first, a mark point (Mark point) in the original wiring image is obtained. The Mark point is a position identification point in the circuit board design where the PCB is applied to an automatic pick-and-place machine (or automatic placement machine). The preferred shapes of the Mark point may include a circle, a T-shape, or a cross shape. The color of the Mark point is distinctly different from the background color of the surrounding area. Additionally, in order to ensure the identification effect of the printing equipment and the placement equipment, the clear area around the Mark point should be free of other alignments, silkscreen or pads, etc. Each surface-mount side of the PCB board has at least one pair of Mark points located in the diagonal direction of the PCB board, as far away from each other as possible, and asymmetric about the center. Furthermore, the acquisition of the mark point may be realized in the following ways. Firstly, an original wiring image is acquired, and then grayscale processing is performed on the original wiring image to obtain a grayscale wiring image. Secondly, binarization processing is performed on the grayscale wiring image to obtain a binarized wiring image, and then the binarized wiring image is filtered based on an attribute feature possessed by the mark point to obtain the mark point.

Specifically, in the process of practical application, it is first necessary to acquire the original wiring image from the surface of the metal wire to be detected by means of a preset image acquisition device. The image acquisition device includes a large target surface industrial camera and an industrial telecentric lens. In the process of controlling the image acquisition device to acquire the original wiring image, it is first necessary to configure an incident angle of a light source between the industrial telecentric lens and the metal wire surface to be detected; then, based on the incident angle, the large target surface industrial camera is controlled to acquire the original wiring image from the metal wire surface to be detected through the industrial telecentric lens. The light source used in the image acquisition process can be realized by a ring-shaped light source, one or more point light sources, and one or more strip light sources individually, or in combination, and the present example does not make any special limitations in this regard. Additionally, in order to ensure the quality of the original wiring image acquired, the incident angle of the light source is required to be between 60° and 85°. It should be noted that, in the process of acquiring the original wiring image, the image can be acquired by means of high-angle dark-field light. The high-angle refers to a high angle of incidence of the light source. The dark-field refers to non-total reflection. Since the surface of the metal wire is a smooth surface, total reflection occurs when the high-angle light strikes on the metal wire, and thus there is no reflected light being captured by the camera, that is, when there is no crack defect, total reflection occurs and the corresponding original wiring image cannot be acquired. However, when there is a crack on the metal wire, the light strikes on the crack and produces diffuse reflection, so that the reflected light is captured by the camera, thus realizing the capture of the crack features and obtaining the aforementioned original wiring image.

Secondly, after obtaining the aforementioned original wiring image, a Gaussian filtering process may be performed on the original wiring image to eliminate noisy points included in the original wiring image. The specific Gaussian filtering process can be described in the following formulas (1) and (2).

$$B [ i , h ] = w ○ photo \qquad Formula ( 1 )$$

$$w ( i , j ) = \frac{1}{2 {πσ}^{2}} exp ( - \frac{Δ {i}^{2} + Δ {j}^{2}}{2 {σ}^{2}} ) \qquad Formula ( 2 )$$

Here, w represents a Gaussian filter kernel, the size of which is 70*70. Δi and Δj are the absolute values of the horizontal and vertical coordinate offsets from the position (i, j) in the filter kernel to the center of the kernel, respectively. σ² denotes the variance of the Gaussian filter, the specific value of which may be 1.5. Furthermore, the large-scale Gaussian filter kernel is subjected to a matrix convolution operation (denoted as “o”) with the original wiring image (denoted as “photo”), so that the noisy points in the original wiring image can be eliminated. It should be noted that the size of the Gaussian filter kernel and the variance of the Gaussian filter can also take other values, which can be selected by those skilled in the art based on actual needs and is not specifically limited in this example. Additionally, it should be noted that the noisy point involved herein generally refers to a point of less than 3*3 pixels. Certainly, it can also be a point of other pixel sizes, and this example does not impose any special limitations thereon.

Furthermore, after removal of the noisy points is completed, the original wiring image without noisy points can be subjected to grayscale processing to obtain a grayscale wiring image. In the obtained grayscale wiring image, the current brightness value of each pixel point can be classified into any one of the values from 0 to 255 according to the bright intensity of the pixel point. And then, the grayscale wiring image can be subjected to binarization processing to obtain a binarized wiring image. It should be noted that, Mark points, similar to metal wires, have a lower grayscale value compared to other gray metal regions imaged in a dark-field light environment. Therefore, this difference in the grayscale value facilitates the capture of the Mark points, and thus the accuracy of the captured Mark points can be improved on the basis of improving the efficiency of the capture of the Mark points.

The process of binarizing the grayscale wiring image to obtain a binarized wiring image can be realized in the following ways. Firstly, a current brightness value of each pixel point included in the grayscale wiring image is acquired, and whether the current brightness value is greater than a first preset threshold is determined. Secondly, if the current brightness value is greater than the first preset threshold, the current brightness value of this pixel point is replaced with a first preset brightness value; if the current brightness value is less than the first preset threshold, the current brightness value of this pixel point is replaced with a second preset brightness value. Finally, the binarized wiring image is generated based on each pixel point after the replacement of the current brightness value. Specifically, the first preset threshold can be set to 1, or it can be any other value, which is not specifically limited in this example. Subsequently, it is determined whether the current brightness value of each pixel point is greater than the first preset threshold of 1. If it is, the current brightness value of this pixel point can be replaced with the first preset brightness value. If it is not, the current brightness value of this pixel point can be replaced with the second preset brightness value. The settings for the first and second preset brightness values can be adjusted according to the actual requirements, and this example does not impose any specific limitations in this regard.

It should be noted that the purpose of binarization of the original wiring image after the removal of the noisy points is to increase the contrast between the brightness values of the pixel points, so that the brighter parts are brighter and the darker parts are darker, which facilitates the extraction of the center point. Therefore, the selection rules for the first and second preset brightness values can follow the rule of “making the brighter parts brighter and the darker parts darker”. For example, the first preset brightness value can be 255 and the second preset brightness value can be 0. Alternatively, other values that can satisfy the above rule can be selected. The present example does not make any special limitations in this regard.

Furthermore, after the binarized wiring image is obtained, the binarized wiring image can be filtered based on the attribute feature possessed by the mark point to obtain the mark point. Here, the attribute feature possessed by the mark point refers to the morphological feature of the mark point, which may include the dimension (e.g., length and width) and the aspect ratio, etc., of the mark point. Subsequently, the binarized wiring image can be filtered based on the morphological feature to obtain the Mark point.

At this point, the Mark point has been extracted from the original wiring image. Next, it is necessary to determine a first to-be-detected region of the original wiring image based on the Mark point. Specifically, this can be realized in the following ways. Firstly, a center point position of the mark point can be calculated based on a starting coordinate position of the mark point in the original wiring image and a dimensional feature of attribute features possessed by the mark point. Secondly, a dimension of the first to-be-detected region is determined based on a proportion of a metal wire included in the original wiring image relative to the original wiring image. Finally, the first to-be-detected region is selected from the original wiring image based on the center point position and the dimension of the first to-be-detected region.

Specifically, the first to-be-detected region may be considered as a Region Of Interest (ROI). In the process of selecting the first to-be-detected region, first, it is necessary to calculate the center point position of the Mark point. The center point position of the Mark point can be calculated in the following ways. Firstly, the starting coordinate position of the Mark point in the original wiring image (e.g., the starting coordinate point's position of the upper-left corner), as well as the length value and the width value, are determined. Secondly, based on the starting coordinate position and the length and width values, the center point position (x1, y1) can be obtained. Furthermore, it is also necessary to set the dimension (e.g., width and height) of the ROI according to the size of the area occupied by the metal wire in the original wiring image. Finally, the center point position (x1, y1) of the Mark point is taken as the reference point, and the image of the ROI region is cropped from the original image based on the dimension (e.g., width and height) of the ROI to generate the ROI image (i.e., the first to-be-detected region). The resulting first to-be-detected region can be specifically referred to FIG. 6.

In step S120, boundary sharpening is performed on the first to-be-detected region to determine a second to-be-detected region, and a target detection image is generated based on the first to-be-detected region and the second to-be-detected region.

In this exemplary embodiment, first, boundary sharpening is performed on the first to-be-detected region to determine a second to-be-detected region. Here, the “boundary sharpening” refers to sharpening a boundary of the metal wire included in the first to-be-detected region. The specific boundary sharpening process can be realized in the following ways. Firstly, dilation and erosion processing is performed on the first to-be-detected region to obtain an intermediate detection region. Secondly, erosion and dilation processing is performed on the intermediate detection region to obtain the second to-be-detected region.

In one exemplary embodiment, performing dilation and erosion processing on the first to-be-detected region to obtain the intermediate detection region can be realized in the following ways. Firstly, a first pixel point to be processed is extracted from the first to-be-detected region, and the first pixel point to be processed is deleted. Here, a size of the first pixel point to be processed does not exceed a first preset pixel value, and the first pixel point to be processed has a current brightness value greater than a first preset threshold. Secondly, smoothing processing is performed on a boundary line of a metal wire included in the first to-be-detected region, and an adhesion between two adjacent metal wires is disconnected to obtain the intermediate detection region. That is, in the specific application process, the first to-be-detected region (the aforementioned ROI image) is first binarized based on a second preset threshold, and then subjected to dilation and erosion processing to eliminate small bright spots (i.e., the first pixel point to be processed whose pixel point size does not exceed the first preset pixel value and whose current brightness value is greater than the first preset threshold) in the region of the metal wires. At the same time, smoothing processing is performed on the boundary of the metal wire, and the adhesion between two adjacent metal wires is disconnected to obtain the intermediate detection region.

In one embodiment, performing erosion and dilation processing on the intermediate detection region to obtain the second to-be-detected region can be realized in the following ways. Firstly, a second pixel point to be processed is extracted from the intermediate detection region and the second pixel point to be processed is filled. Here, a size of the second pixel point to be processed does not exceed a first preset pixel value, and a current brightness value of the second pixel point to be processed is less than a first preset threshold. Secondly, a disconnected portion of the metal wire included in the intermediate detection region is filled, and secondary smoothing processing is performed on a boundary line of the metal wire on the basis of not changing an area of the metal wire, to obtain the second to-be-detected region. That is, small dark spots (i.e., the second pixel point to be processed whose current brightness value is less than the first preset threshold and whose pixel point size does not exceed the first preset pixel value) and disconnected contour lines within the metal wires included in the intermediate detection region may be filled and the boundary of the metal wire may be smoothed again without changing the area of the metal wire.

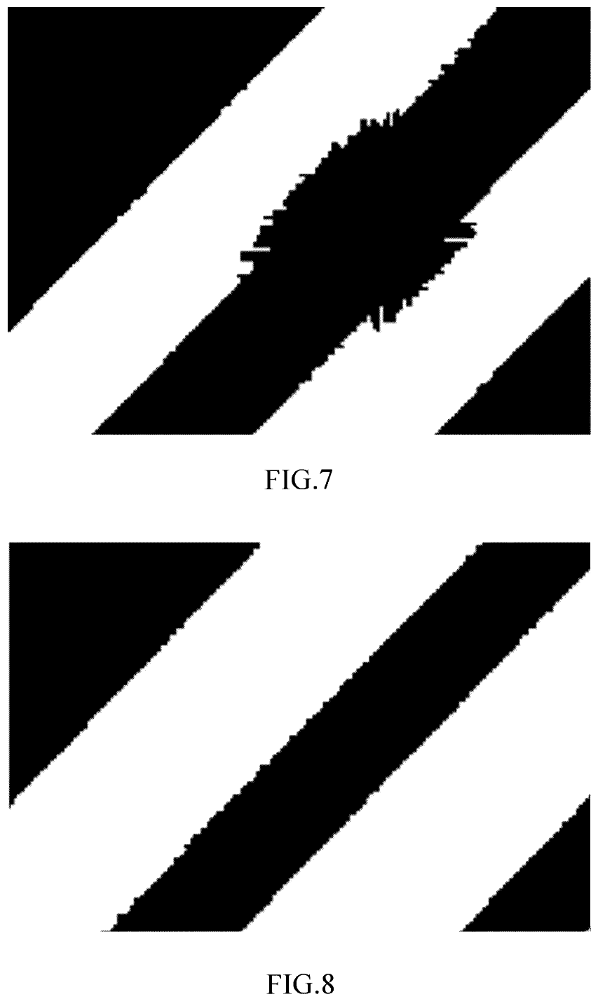

It should be noted that the dilation and erosion processing of an image are completely different operations from the erosion and dilation processing of an image. Typically, to preserve image features as much as possible, dilation and erosion operations are performed in pairs. In the scheme described in this exemplary embodiment, the purpose of performing dilation first and then erosion is to eliminate small bright spots within the metal wire region, smooth the boundary of the metal wire, and disconnect the adhesion between adjacent metal wires. Furthermore, the purpose of performing erosion first and then dilation is to fill in small dark spots and disconnected contours within the metal wire, and to smooth the boundary of the metal wire again without changing its area. Certainly, due to different operational purposes and the types of interference to be eliminated, the parameter selection for dilation-erosion and erosion-dilation will differ, with the specific values chosen being optimized based on the image features, without any special limitations imposed by this application. Additionally, when the binarized image has significant noisy points that damage the boundary of the metal wire, the boundary can be restored through one or several times of sharpening processing. The metal wires before the boundary sharpening processing can be referred to FIG. 7, and the metal wires after the boundary sharpening processing can be referred to FIG. 8.

At this point, the boundary sharpening process of the metal wire included in the first to-be-detected region is completed in full. Furthermore, when the boundary sharpening is completed, it is also necessary to generate a target detection image. Here, generating the target detection image according to the first to-be-detected region and the second to-be-detected region can be realized in the following ways. Firstly, a difference operation is performed on a first grayscale value of each pixel point included in the first to-be-detected region and a second grayscale value of each pixel point included in the second to-be-detected region to obtain a third grayscale value, and whether the third grayscale value satisfies a preset condition is determined. Secondly, if the third grayscale value satisfies the preset condition, the third grayscale value is taken as the target grayscale value of the pixel point; if the third grayscale value does not satisfy the preset condition, the third grayscale value is replaced, and the replaced third grayscale value is taken as the target grayscale value of the pixel point. Finally, the target detection image is generated based on the target grayscale value of each pixel point.

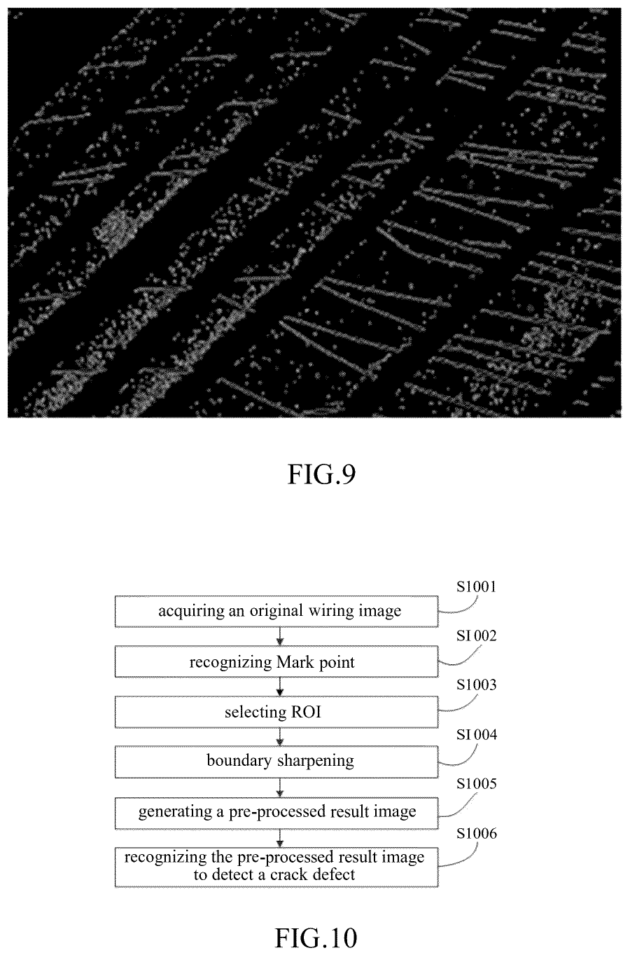

Specifically, in the process of generating the target detection image, a subtraction can be performed between the ROI image (i.e., the first to-be-detected region) and a boundary sharpened image (i.e., the second to-be-detected region) described above to obtain the target detection image, which can also be referred to as a pre-processed result image. Since the region of the metal wire in the boundary sharpened image (i.e., the second to-be-detected region) is all black, and the region of the non-metal wire is all white, the image of the region of the metal wire after subtraction will be completely preserved, and the image of the region of the non-metal wire is all black. And then, the result image after subtraction will be binarized to identify the boundaries to obtain the pre-processed result image (i.e., the target detection image) as shown in FIG. 9. It can be seen from the pre-processed result image as shown in FIG. 9 that the edges of the metal wires have been completely eliminated, and the complexity of the background of the image has been reduced, and it can be used subsequently with the simple target recognition algorithm to filter out the cracks. It should be noted that, the process of image subtraction operation for the first to-be-detected region and the second to-be-detected region can be realized in the following ways. The grayscale values of the corresponding pixel points of the two images with the same rows and columns are subtracted one by one. If the subtraction results a certain pixel point value less than 0, the value of this pixel point is determined as 0. Since the boundary sharpened region is a binarized image, the grayscale value of the metal wire region is 0 and the grayscale value of the non-metal wire region is 255. After the boundary sharpening region is subtracted from the ROI image, the data of the metal wire region in the result image is completely preserved, and the pixel point value of the non-metal wire region is 0, so that the interference between the wires can be eliminated, which can achieve the purpose of improving the accuracy of the target detection image obtained.

In step S130, image recognition is performed on the target detection image to detect a crack defect included in the original wiring image.

Specifically, the crack defect included in the original wiring image can be detected by image recognition of the target detection image using a preset image recognition model. The image recognition model includes an edge detection model, a convolutional neural network model, a recurrent neural network model, and a deep neural network model, among others. It should be noted that, as can be seen from the pre-processed result image shown in FIG. 9, the edges of the metal wires have been completely eliminated, and the complexity of the image background has been reduced, and the cracks can be subsequently identified/filtered with a simple target recognition algorithm. Taking the traditional target recognition algorithm as an example, in the process of identification/filtering of the cracks, since the defective target is mainly the crack (linear defect), the target recognition can be carried out using edge detection operators. The commonly used edge detection operators are Roberts operator, Sobel operator, Laplace operator, Canny operator, etc. Furthermore, one of these operators is selected, and the appropriate parameters are adjusted to identify the crack (some interference may also be introduced), and then secondary filtering is carried out by means of morphology (mainly length, aspect ratio, straight line angle), to achieve a more accurate capture of the target defects.

It should be further noted that, to further improve the detection results of the crack defects, the present application introduces a convolutional neural network model, a recurrent neural network model, and a deep neural network model for the recognition of the crack defects. Since the images input to the convolutional neural network model, the recurrent neural network model and the deep neural network model are pre-processed images, there is no need to carry out other processing in the specific recognition process, and the target detection image is directly input to the convolutional neural network model or the recurrent neural network model or the deep neural network model, and the output result obtained is the corresponding detection result for the crack defects. Certainly, since the crack defect detection is different from other types of image recognition, the training dataset and the test dataset are also images related to the crack defect in the process of pre-training the above model.

Hereinafter, the method for detecting the crack defect involved in the exemplary embodiments of the present disclosure is further explained and illustrated in connection with FIG. 10. Specifically, with reference to FIG. 10, the following steps may be included.

Step S1001, acquiring an original wiring image. Specifically, the image acquisition can be carried out using a large target surface industrial camera and industrial telecentric lens. Since the surface of the metal wire is a smooth surface, when the high-angle light strikes on the metal wire, total reflection will occur, and thus there is no reflected light to be captured by the camera. However, when there is a crack on the metal wire, the light strikes on the crack and produces diffuse reflection, so that there is reflected light to be captured by the camera, thus realizing the capture of the crack features.

Step S1002, recognizing a Mark point. Specifically, the circuit region will be pre-set with a metal cross-shaped or T-type Mark point for easy detection. In addition, Mark points, like metal wires, have a lower grayscale value compared to other gray metal regions imaged in a dark-field light environment. Therefore, this difference in the grayscale value can realize the capture of the Mark point. For example, after applying Gaussian filtering to the original captured image to remove noisy points, the image can be binarized using a set threshold value of 1. Subsequently, the binarized image can be filtered based on morphological features (e.g., the dimension of the Mark point, aspect ratio, etc.).

Step S1003, selecting a ROI. Specifically, a dimension of the ROI can be set to “(width, height)” according to the size of the region where the metal wire is located, and then, by using a Mark center point (x1, y1) as a reference point, the ROI region is cropped from the original image to generate the ROI image.

Step S1004, boundary sharpening. Specifically, the ROI image described above is subjected to a dilation and erosion process to eliminate small bright spots within the metal wire region while smoothing the metal wire boundary and disconnecting the adhesion of adjacent wire pieces. And then, the ROI image is subjected to an erosion and dilation process to fill in the small dark spots within the metal wire and the disconnected contour lines, and to smooth the boundary of the metal wire again while keeping the area of the metal wire unchanged.

Step S1005, generating a pre-processed result image. Specifically, subtraction is performed between the ROI image and the boundary sharpened image described above. Since in the boundary sharpened image, the metal wire regions are completely black and the non-metal wire regions are completely white, after the subtraction, the metal wire regions in the result image will be fully preserved while the non-metal wire regions will be completely black. Then, the metal wire regions in the result image after the subtraction are binarized and the boundaries are identified to obtain the pre-processed result image.

Step S1006, recognizing the pre-processed result image to detect a crack defect. Specifically, as can be seen from the pre-processed result image, the boundaries of the metal wires have been completely eliminated, and the complexity of the image background has been reduced, and the crack defect can be subsequently filtered out using a simple target recognition algorithm.

In this point, the identification/filtering of crack defects have been completed. Based on the schemes described above, it can be concluded that the method disclosed in the exemplary embodiments of the present disclosure, on the one hand, can solve the problem of the low efficiency and the low reliability (the micro-cracks do not directly cause short-circuits in the early stages, and are prone to develop into larger cracks in the later stages) of the method for measuring the metal continuity by the electrical means in the prior art, and can repair the crack defects identified, which in turn can avoid the problem of short circuits. On the other hand, it solves the problem of high difficulty in adopting visual inspection methods in the prior art, without the need to identify crack defects through visual inspection methods.

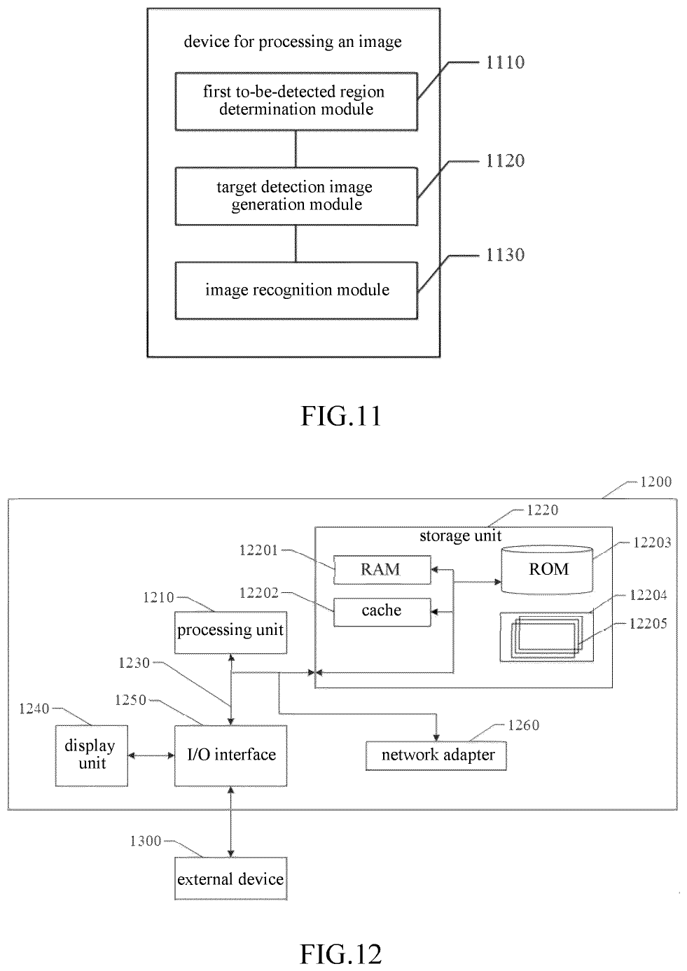

An exemplary embodiment of the present disclosure also provides a device for processing an image. Specifically, with reference to FIG. 11, the device for processing the image may include a first to-be-detected region determination module 1110, a target detection image generation module 1120, and an image recognition module 1130.

The first to-be-detected region determination module 1110 is configured to acquire a mark point in an original wiring image, and to determine a first to-be-detected region of the original wiring image based on the mark point.

The target detection image generation module 1120 is configured to perform boundary sharpening on the first to-be-detected region to determine a second to-be-detected region, and to generate a target detection image based on the first to-be-detected region and the second to-be-detected region.

The image recognition module 1130 is configured to perform image recognition on the target detection image to detect a crack defect included in the original wiring image.

In an exemplary embodiment of the present disclosure, acquiring the mark point in the original wiring image includes:
acquiring the original wiring image, and performing grayscale processing on the original wiring image to obtain a grayscale wiring image; and
performing binarization processing on the grayscale wiring image to obtain a binarized wiring image, and filtering the binarized wiring image based on an attribute feature possessed by the mark point to obtain the mark point.

In an exemplary embodiment of the present disclosure, performing binarization processing on the grayscale wiring image to obtain the binarized wiring image includes:
acquiring a current brightness value of each pixel point included in the grayscale wiring image and determining whether the current brightness value is greater than a first preset threshold;
in response to the current brightness value being greater than the first preset threshold, replacing the current brightness value of the pixel point with a first preset brightness value;
in response to the current brightness value being less than the first preset threshold, replacing the current brightness value of the pixel point with a second preset brightness value; and
generating the binarized wiring image based on each pixel point after the replacement of the current brightness value.

In an exemplary embodiment of the present disclosure, the device for processing the image further includes:
an original wiring image acquisition module, which can be configured to acquire, by a preset image acquisition device, the original wiring image from a metal wire surface to be detected, where the image acquisition device includes a large target surface industrial camera and an industrial telecentric lens.

In an exemplary embodiment of the present disclosure, acquiring, by the preset image acquisition device, the original wiring image from the metal wire surface to be detected includes: configuring an incident angle of a light source between the industrial telecentric lens and the metal wire surface to be detected; and controlling, based on the incident angle, the large target surface industrial camera to acquire the original wiring image from the metal wire surface to be detected through the industrial telecentric lens.

In one exemplary embodiment of the present disclosure, the light source includes one or more of: a ring-shaped light source, one or more point light sources, and one or more strip light sources; and the incident angle ranges from 60° to 85°.

In an exemplary embodiment of the present disclosure, determining the first to-be-detected region of the original wiring image based on the mark point includes:
calculating a center point position of the mark point based on a starting coordinate position of the mark point in the original wiring image and a dimensional feature of attribute features possessed by the mark point;
determining a dimension of the first to-be-detected region based on a proportion of a metal wire included in the original wiring image relative to the original wiring image; and
selecting the first to-be-detected region from the original wiring image based on the center point position of the mark point and the dimension of the first to-be-detected region.

In an exemplary embodiment of the present disclosure, performing boundary sharpening on the first to-be-detected region to determine the second to-be-detected region includes:
performing dilation and erosion processing on the first to-be-detected region to obtain an intermediate detection region; and
performing erosion and dilation processing on the intermediate detection region to obtain the second to-be-detected region.

In an exemplary embodiment of the present disclosure, performing dilation and erosion processing on the first to-be-detected region to obtain the intermediate detection region includes: extracting a first pixel point to be processed from the first to-be-detected region and deleting the first pixel point to be processed, where a size of the first pixel point to be processed does not exceed a first preset pixel value, and a current brightness value of the first pixel point to be processed is greater than a first preset threshold; and
performing smoothing processing on a boundary line of a metal wire included in the first to-be-detected region, and disconnecting an adhesion between two adjacent metal wires to obtain the intermediate detection region.

In an exemplary embodiment of the present disclosure, performing erosion and dilation processing on the intermediate detection region to obtain the second to-be-detected region includes: extracting a second pixel point to be processed from the intermediate detection region and
filling the second pixel point to be processed, where a size of the second pixel point to be processed does not exceed a first preset pixel value, and a current brightness value of the second pixel point to be processed is less than a first preset threshold; and
filling a disconnected portion of a metal wire included in the intermediate detection region, and performing secondary smoothing processing on a boundary line of the metal wire without changing an area of the metal wire to obtain the second to-be-detected region.

In an exemplary embodiment of the present disclosure, generating the target detection image based on the first to-be-detected region and the second to-be-detected region includes:
performing a difference operation on a first grayscale value of each pixel point included in the first to-be-detected region and a second grayscale value of each pixel point included in the second to-be-detected region to obtain a third grayscale value, and determining whether the third grayscale value satisfies a preset condition;
in response to the third grayscale value satisfying the preset condition, determining the third grayscale value as a target grayscale value of the pixel point;
in response to the third grayscale value failing to satisfy the preset condition, replacing the third grayscale value and determining the replaced third grayscale value as the target grayscale value of the pixel point; and
generating the target detection image based on the target grayscale value of each pixel point.

In an exemplary embodiment of the present disclosure, performing image recognition on the target detection image to detect the crack defect included in the original wiring image includes:
performing image recognition on the target detection image by a preset image recognition model to detect the crack defect included in the original wiring image;
where the image recognition model includes one or more of: an edge detection model, a convolutional neural network model, a recurrent neural network model, or a deep neural network model.

The specific details of each module in the above-described device for processing the image have been described in detail in the corresponding method for processing the image, and therefore will not be repeated here.

It should be noted that although a number of modules or units of the device for action execution are mentioned in the detailed description above, the division of modules or units is not mandatory. Actually, according to embodiments of the present disclosure, the features and functions of two or more modules or units described above may be materialized in a single module or unit. Conversely, the features and functions of one module or unit described above may be further divided to be materialized by a plurality of modules or units.

Furthermore, although the various steps of the method in the present disclosure are depicted in the accompanying drawings in a particular order, it is not required or implied that these steps must be performed in that particular order or that all of the steps shown must be performed in order to achieve the desired result. Additional or alternatively, certain steps may be omitted, multiple steps may be combined to be performed as a single step, and/or a single step may be broken down to be performed as multiple steps, etc.

In an exemplary embodiment of the present disclosure, there is also provided an electronic device that can implement the methods described above.

Those skilled in the art will appreciate that aspects of the present disclosure may be implemented as systems, methods, or program products. Accordingly, aspects of the present disclosure may be specifically realized in the form of: a complete hardware implementation, a complete software implementation (including firmware, microcode, etc.), or a combination of hardware and software aspects, which may be collectively referred to herein as a “circuit”, “module”, or “system”.

An electronic device 1200 according to this embodiment of the present disclosure is described below with reference to FIG. 12. The electronic device 1200 shown in FIG. 12 is merely an example and should not impose any limitations on the functionality and scope of use of embodiments of the present disclosure.

As shown in FIG. 12, the electronic device 1200 is represented in the form of a general purpose computing device. Components of the electronic device 1200 may include, but are not limited to, the at least one processing unit 1210 described above, the at least one storage unit 1220 described above, a bus 1230 that connects the different system components, including the storage unit 1220 and the processing unit 1210, and a display unit 1240.

The storage unit stores program code, and the program code may be executed by the processing unit 1210, causing the processing unit 1210 to perform the steps described above according to various exemplary embodiments of the present disclosure. For example, the processing unit 1210 may perform the following steps as shown in FIG. 1: step S110, acquiring a mark point in an original wiring image, and determining a first to-be-detected region of the original wiring image based on the mark point; step S120, performing boundary sharpening on the first to-be-detected region to determine a second to-be-detected region, and generating a target detection image based on the first to-be-detected region and the second to-be-detected region; and step S130, performing image recognition on the target detection image to detect a crack defect included in the original wiring image.

The storage unit 1220 may include a readable medium in the form of a volatile storage unit, such as a random access memory (RAM) unit 12201 and/or a cache memory unit 12202, and may further include a read-only memory (ROM) unit 12203.

The storage unit 1220 may also include a program/utility 12204 having a set of program modules 12205 (at least one program module) and these program modules 12205 include, but are not limited to: an operating system, one or more applications, other program modules, and program data, and each of these examples, or some combination thereof, may include an implementation of a network environment.

The bus 1230 may represent one or more of several types of bus structures, including a memory bus or memory controller, a peripheral bus, a graphics acceleration port, a processing unit, or a local bus using any of various bus architectures.

The electronic device 1200 may also be in communication with one or more external devices 1300 (e.g., keyboards, pointing devices, Bluetooth® devices, etc.), and may also be in communication with one or more devices that enable a user to interact with the electronic device 1200, and/or with any device (e.g., routers, modems, etc.) that enables the electronic device 1200 to be in communication with one or more other computing devices. Such communication may be carried out via the input/output (I/O) interface 1250. And, the electronic device 1200 may also communicate with one or more networks (e.g., a local area network (LAN), a wide area network (WAN), and/or a public network, such as the Internet) via the network adapter 1260. As shown in the FIG. 12, the network adapter 1260 communicates with other modules of the electronic device 1200 via the bus 1230. It should be understood that, although not shown in the figures, other hardware and/or software modules may be used in conjunction with electronic device 1200, including, but not limited to: microcode, device drives, redundant processing units, external disk drive arrays, RAID systems, tape drives, and data backup storage systems.

Through the description of the above embodiments, it is easy for those skilled in the art to understand that the exemplary embodiments described here can be implemented through software, or through a combination of software and necessary hardware. Therefore, the technical solution according to the embodiments of this disclosure can be embodied in the form of a software product, which can be stored on a non-volatile storage medium (such as a CD-ROM, USB drive, portable hard drive, etc.) or on a network, and includes instructions for causing a computing device (such as a personal computer, server, terminal device, or network device etc.) to execute the method according to the embodiments of this disclosure.

In an exemplary embodiment of the present disclosure, there is also provided a computer-readable storage medium having stored thereon a program product capable of implementing the method described above in the present specification. In some possible embodiments, aspects of the present disclosure may also be implemented in the form of a program product including program code which, when run on a terminal device, is used to cause the terminal device to perform the steps described above according to various exemplary embodiments of the present disclosure.

A program product for implementing the methods described above according to embodiments of the present disclosure may employ a portable compact disk read-only memory (CD-ROM) and include program code, and may run on a terminal device, such as a personal computer. However, the program products of the present disclosure are not limited thereto. As used herein, the readable storage medium may be any tangible medium that contains or stores a program that may be used by or in combination with an instruction execution system, apparatus, or device.

The program product may employ any combination of one or more readable mediums. The readable medium may be a readable signal medium or a readable storage medium. The readable storage medium may, for example, be, but is not limited to, a system, or apparatus or device that is electrical, magnetic, optical, electromagnetic, infrared, or semiconducting, or any combination of the above. More specific examples (a non-exhaustive list) of the readable storage medium include: an electrical connection having one or more wires, a portable disk, a hard disk, a random access memory (RAM), a read-only memory (ROM), an erasable programmable read-only memory (EPROM or flash memory), a fiber optic, a portable compact disk read-only memory (CD-ROM), an optical storage device, a magnetic storage device, or any suitable combination thereof.

The computer readable signal medium may include a data signal propagated in the baseband or as part of a carrier carrying readable program code. Such propagated data signals may take a variety of forms, including, but not limited to, electromagnetic signals, optical signals, or any suitable combination thereof. The readable signal medium may also be any readable medium other than a readable storage medium that may send, propagate, or transmit a program for use by, or in conjunction with, an instruction execution system, apparatus, or device.

The program code contained on the readable medium may be transmitted using any suitable medium including, but not limited to, wireless, wired, fiber optic cable, RF, etc., or any suitable combination thereof.

Program code for performing the operations of the present disclosure may be written in any combination of one or more programming languages, the programming languages including object-oriented programming languages, such as Java, C++, etc., and also conventional procedural programming languages, such as the “C” language or similar programming languages. The program code may be executed entirely on the user computing device, partially on the user device, as a stand-alone software package, partially on the user computing device and partially on a remote computing device, or entirely on a remote computing device or server. In situations involving a remote computing device, the remote computing device may be connected to the user computing device via any kind of network, including a local area network (LAN) or a wide area network (WAN), or may be connected to an external computing device (e.g., by utilizing an Internet service provider via the Internet).

Furthermore, the aforementioned figures are merely schematic illustrations of the processes included in the methods of exemplary embodiments of this disclosure, and are not intended for limitation. It is easily understood that the processes depicted in the figures do not indicate or restrict the chronological order of these processes. Additionally, it is also easily understood that these processes can be executed synchronously or asynchronously, for example, in multiple modules.

After considering the specification and practicing the invention disclosed here, those skilled in the art will easily conceive of other embodiments of this disclosure. This application is intended to cover any variations, uses, or adaptive modifications of this disclosure, which follow the general principles of this disclosure and include commonly known knowledge or customary technical means in this field that are not disclosed herein. The specification and examples are to be regarded as exemplary only, and the true scope and spirit of this disclosure are indicated by the claims.

1. A method for processing an image, comprising:
acquiring a mark area in an original wiring image, and determining a first to-be-detected region of the original wiring image based on the mark area;
performing boundary sharpening on the first to-be-detected region to determine a second to-be-detected region, and generating a target detection image based on the first to-be-detected region and the second to-be-detected region; and
performing image recognition on the target detection image to detect a crack defect in the original wiring image.

2. The method for processing the image according to claim 1, wherein acquiring the mark area in the original wiring image comprises:
acquiring the original wiring image, and performing grayscale processing on the original wiring image to obtain a grayscale wiring image; and
performing binarization processing on the grayscale wiring image to obtain a binarized wiring image, and filtering the binarized wiring image based on an attribute feature possessed by the mark area to obtain the mark area.

3. The method for processing the image according to claim 2, wherein performing binarization processing on the grayscale wiring image to obtain the binarized wiring image comprises:
acquiring a current brightness value of each pixel point included in the grayscale wiring image and determining whether the current brightness value is greater than a first preset threshold;
in response to the current brightness value being greater than the first preset threshold, replacing the current brightness value of the pixel point with a first preset brightness value;
in response to the current brightness value being less than the first preset threshold, replacing the current brightness value of the pixel point with a second preset brightness value; and
generating the binarized wiring image based on each pixel point after the replacement of the current brightness value.

4. The method for processing the image according to claim 1, further comprising:
acquiring, by a preset image acquisition device, the original wiring image from a metal wire surface to be detected, wherein the image acquisition device comprises a large target surface industrial camera and an industrial telecentric lens.

5. The method for processing the image according to claim 4, wherein acquiring, by the preset image acquisition device, the original wiring image from the metal wire surface to be detected comprises:
configuring an incident angle of a light source between the industrial telecentric lens and the metal wire surface to be detected; and
controlling, based on the incident angle, the large target surface industrial camera to acquire the original wiring image from the metal wire surface to be detected through the industrial telecentric lens.

6. The method for processing the image according to claim 5, wherein the light source comprises one or more of: a ring-shaped light source, one or more point light sources, and one or more strip light sources; and wherein the incident angle ranges from 60° to 85°.

7. The method for processing the image according to claim 1, wherein determining the first to-be-detected region of the original wiring image based on the mark area comprises:
calculating a center point position of the mark area based on a starting coordinate position of the mark area in the original wiring image and a dimensional feature of attribute features possessed by the mark area;
determining a dimension of the first to-be-detected region based on a proportion of a metal wire included in the original wiring image relative to the original wiring image; and
selecting the first to-be-detected region from the original wiring image based on the center point position of the mark area and the dimension of the first to-be-detected region.

8. The method for processing the image according to claim 1, wherein performing boundary sharpening on the first to-be-detected region to determine the second to-be-detected region comprises:
performing dilation and erosion processing on the first to-be-detected region to obtain an intermediate detection region; and
performing erosion and dilation processing on the intermediate detection region to obtain the second to-be-detected region.

9. The method for processing the image according to claim 8, wherein performing dilation and erosion processing on the first to-be-detected region to obtain the intermediate detection region comprises:
extracting a first pixel point to be processed from the first to-be-detected region and deleting the first pixel point to be processed, wherein a size of the first pixel point to be processed is less than or equal to a first preset pixel value, and a current brightness value of the first pixel point to be processed is greater than a first preset threshold; and
performing smoothing processing on a boundary line of a metal wire included in the first to-be-detected region and disconnecting an adhesion between two adjacent metal wires to obtain the intermediate detection region.

10. The method for processing the image according to claim 8, wherein performing erosion and dilation processing on the intermediate detection region to obtain the second to-be-detected region comprises:
extracting a second pixel point to be processed from the intermediate detection region and filling the second pixel point to be processed, wherein a size of the second pixel point to be processed is less than or equal to a first preset pixel value, and a current brightness value of the second pixel point to be processed is less than a first preset threshold; and
filling a disconnected portion of a metal wire included in the intermediate detection region and performing secondary smoothing processing on a boundary line of the metal wire without changing an area of the metal wire to obtain the second to-be-detected region.

11. The method for processing the image according to claim 1, wherein generating the target detection image based on the first to-be-detected region and the second to-be-detected region comprises:
performing a difference operation on a first grayscale value of each pixel point included in the first to-be-detected region and a second grayscale value of each pixel point included in the second to-be-detected region to obtain a third grayscale value, and determining whether the third grayscale value satisfies a preset condition;
in response to the third grayscale value satisfying the preset condition, determining the third grayscale value as a target grayscale value of the pixel point;
in response to the third grayscale value failing to satisfy the preset condition, replacing the third grayscale value and determining the replaced third grayscale value as the target grayscale value of the pixel point; and
generating the target detection image based on the target grayscale value of each pixel point.

12. The method for processing the image according to claim 1, wherein performing image recognition on the target detection image to detect the crack defect included in the original wiring image comprises:
performing image recognition on the target detection image by a preset image recognition model to detect the crack defect included in the original wiring image;
wherein the image recognition model comprises one or more of: an edge detection model, a convolutional neural network model, a recurrent neural network model, or a deep neural network model.

13. (canceled)

14. A non-transitory computer-readable storage medium, having stored thereon a computer program which, when executed by a processor, causes the processor to perform the method of claim 1.

15. An electronic device, comprising:
a processor; and
a memory configured to store instructions executable by the processor;
wherein the processor is configured to perform the method of claim 1 by executing the instructions.

16. The electronic device according to claim 15, wherein the processor is further configured to:
acquire the original wiring image, and perform grayscale processing on the original wiring image to obtain a grayscale wiring image; and
perform binarization processing on the grayscale wiring image to obtain a binarized wiring image, and filter the binarized wiring image based on an attribute feature possessed by the mark area to obtain the mark area.

17. The electronic device according to claim 16, wherein the processor is further configured to:
acquire a current brightness value of each pixel point included in the grayscale wiring image and determine whether the current brightness value is greater than a first preset threshold;
in response to the current brightness value being greater than the first preset threshold, replace the current brightness value of the pixel point with a first preset brightness value;
in response to the current brightness value being less than the first preset threshold, replace the current brightness value of the pixel point with a second preset brightness value; and
generate the binarized wiring image based on each pixel point after the replacement of the current brightness value.

18. The electronic device according to claim 15, wherein the processor is further configured to:
acquire, by a preset image acquisition device, the original wiring image from a metal wire surface to be detected, wherein the image acquisition device comprises a large target surface industrial camera and an industrial telecentric lens.

19. The electronic device according to claim 18, wherein the processor is further configured to:
configure an incident angle of a light source between the industrial telecentric lens and the metal wire surface to be detected; and
control, based on the incident angle, the large target surface industrial camera to acquire the original wiring image from the metal wire surface to be detected through the industrial telecentric lens.

20. The electronic device according to claim 15, wherein the processor is further configured to:
calculate a center point position of the mark area based on a starting coordinate position of the mark area in the original wiring image and a dimensional feature of attribute features possessed by the mark area;
determine a dimension of the first to-be-detected region based on a proportion of a metal wire included in the original wiring image relative to the original wiring image; and
select the first to-be-detected region from the original wiring image based on the center point position of the mark area and the dimension of the first to-be-detected region.

21. The electronic device according to claim 15, wherein the processor is further configured to:
perform dilation and erosion processing on the first to-be-detected region to obtain an intermediate detection region; and
perform erosion and dilation processing on the intermediate detection region to obtain the second to-be-detected region.
